(19) United States
(12) Patent Application Publication
(10) Pub. No.: US 2007/0046579 A1
(43) Pub. Date: Mar. 1, 2007

(54) PLASMA DISPLAY APPARATUS

(75) Inventors: Hai Young Jung, Inchun-si (KR); Byung Nam Ahn, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/467,060

(22) Filed: Aug. 24, 2006

(30) Foreign Application Priority Data
Aug. 25, 2005 (KR) 10-2005-0078487
Sep. 6, 2005 (KR) 10-2005-0082938
Sep. 29, 2005 (KR) 10-2005-0091352

(51) Int. Cl. G09G 3/28

(52) U.S. Cl. 345/68

(57) ABSTRACT

There is provided a plasma display apparatus. The plasma display apparatus includes a scan-up switch and a scan-down switch whose one ends are connected to the panel so as to apply a scan signal to a panel; and a scan switch that is connected to a node that is positioned on a path of a resonance current flowing to the panel and the scan-up switch therebetween. Therefore, it is possible to reduce a manufacturing cost of a driving circuit for driving a panel.

This Nonprovisional application claims priority under 35 U.S.C. §119(a) on Patent Application No. 10-2005-0078487 filed in Korea on Aug. 25, 2005, Patent Application No. 10-2005-0082938 filed in Korea on Sep. 6, 2005 and Patent Application No. 10-2005-0091352 filed in Korea on Sep. 29, 2005, the entire contents of which are hereby incorporated by reference.

### BACKGROUND OF THE INVENTION

1. Field of the Invention

The present invention relates to a plasma display apparatus, and more particularly, to a plasma display apparatus that generates signals for driving a plasma display panel to apply the signals to the panel.

2. Description of the Conventional Art

In general, a plasma display apparatus is an apparatus that applies a predetermined voltage to electrodes that are provided in a discharge space to generate a discharge and excites a phosphor with plasma generating when a gas is discharged, thereby displaying an image.

The plasma display apparatus has an advantage that it is easy to manufacture the apparatus as it is easy to increase a size and decrease a thickness thereof and a structure thereof is simple and that brightness and light emitting efficiency are high, compared to other flat display apparatuses.

A plasma display panel is driven in a time division manner into a reset period of initializing all discharge cells that are provided, an address period of selecting a cell in which a discharge is generated, and a sustain period of generating a sustain discharge in the selected cell.

In order to drive the plasma display panel in a time division manner, a plasma display apparatus includes a driving apparatus for generating several driving signals to apply the signals to the panel. The driving apparatus should be provided with an expensive switch having a high withstanding voltage so as to apply a driving signal, whereby there is a problem that a manufacturing cost of the plasma display apparatus increases.

### SUMMARY OF THE INVENTION

The present invention has been made in an effort to solve the above problems of the prior art, and it is an object of the present invention to provide a plasma display apparatus that can reduce a manufacture cost of an apparatus for driving a plasma display panel.

According to an aspect of the present invention, there is provided a plasma display apparatus including: a scan-up switch and a scan-down switch whose one ends are connected to the panel so as to apply a scan signal to a panel; and a scan switch that is connected to a node that is positioned on a path of a resonance current flowing to the panel and the scan-up switch therebetween.

According to another aspect of the present invention, there is provided a plasma display apparatus including: a scan-up switch and a scan-down switch whose one ends are connected to the panel so as to apply a scan signal to a panel; a scan switch that is connected to a node that is positioned on a path of a resonance current flowing to the panel and the scan-up switch therebetween; and a set-up switch whose one end is connected to the node and whose the other end is connected to the other end of the scan-up switch to be turned on so as to apply a set-up signal to the panel.

According to another aspect of the present invention, there is provided a plasma display apparatus including: a charging unit that charges a sustain voltage that is applied to a panel during a sustain period; and a scan signal applying unit that applies a scan bias voltage higher than a lowest voltage of a set-down signal to the panel using a voltage that is charged in the charging unit.

### BRIEF DESCRIPTION OF THE DRAWING

The invention will be described in detail with reference to the following drawings in which like numerals refer to like elements.

FIG. 1 is a perspective view illustrating an embodiment of a plasma display panel structure;

FIG. 2 is a diagram illustrating an embodiment of an electrode arrangement according to the plasma display panel;

FIG. 3 is a diagram illustrating an embodiment of a method in which one frame of an image is driven in a time division manner into a plurality of subfields in a plasma display apparatus;

FIG. 4 is a circuit diagram illustrating a first embodiment of a driving circuit that is provided in a plasma display apparatus according to the present invention;

FIG. 5 is a circuit diagram illustrating a second embodiment of a driving circuit that is provided in the plasma display apparatus according to the present invention;

FIG. 6 is a timing chart illustrating a first embodiment of a driving signal waveform according to the plasma display panel;

FIG. 7 is a circuit diagram illustrating a third embodiment of a driving circuit that is provided in a plasma display apparatus according to the present invention;

FIGS. 8A, 8B, and 8C are timing charts illustrating a second to fourth embodiments of a driving signal waveform according to the plasma display panel;

FIG. 9 is a timing chart illustrating a fifth embodiment of a driving signal waveform according to the plasma display panel;

FIG. 10 is a circuit diagram illustrating a fourth embodiment of a driving circuit that is provided in a plasma display apparatus according to the present invention;

FIGS. 11 and 12 are circuit diagrams illustrating a current pass of the driving circuit shown in FIG. 10;

FIG. 13 is a timing chart illustrating a sixth embodiment of a driving signal waveform according to the plasma display panel;

FIG. 14 is a circuit diagram illustrating a fifth embodiment of a driving circuit that is provided in a plasma display apparatus according to the present invention; and

FIG. 15 is a timing chart illustrating a seventh embodiment of a driving signal waveform according to the plasma display panel.

### DETAILED DESCRIPTION OF THE PREFERRED EMBODIMENT

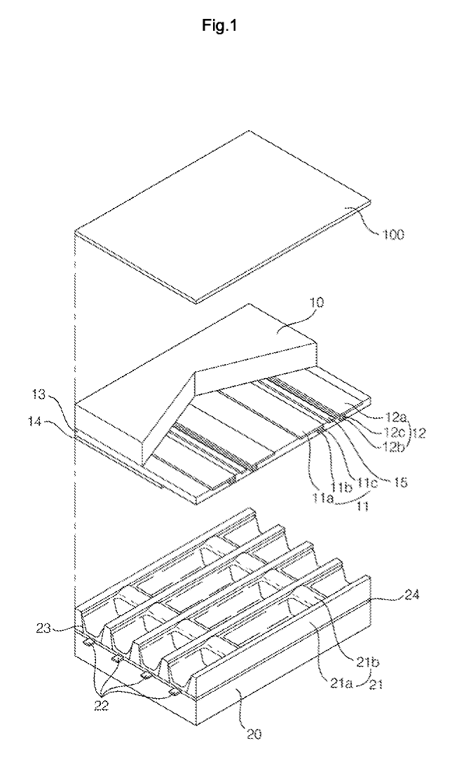

Hereinafter, exemplary embodiments according to the present invention will be described in detail with reference to FIGS. 1 to 15.

FIG. 1 is a perspective view illustrating an embodiment of a plasma display panel structure.

As shown in FIG. 1, a plasma display panel includes a scan electrode 11 and a sustain electrode 12, which are a sustain electrode pair that is formed on an upper substrate 10 and an address electrode 22 that is formed on a lower substrate 20.

The sustain electrode pair 11 and 12 includes transparent electrodes 11a and 12a and bus electrodes 11b and 12b that are generally made of indium-tin-oxide (ITO). The bus electrodes 11b and 12b can be made of a metal such as silver (Ag) and chrome (Cr) or can be made with a stacked structure of chrome/copper/chrome (Cr/Cu/Cr) or chrome/aluminum/chrome (Cr/Al/Cr). The bus electrodes 11b and 12b are formed on the transparent electrodes 11a and 12a to reduce voltage drop due to the transparent electrodes 11a and 12a having high resistance.

According to an embodiment of the present invention, the sustain electrode pair 11 and 12 can be composed of a stacked structure of the transparent electrodes 11 a 12a and the bus electrodes 11b and 12b or only the bus electrodes 11b and 12b without the transparent electrodes 11a and 12a. Because the latter structure does not use the transparent electrodes 11a and 12a, a cost of manufacturing a panel can be decreased. The bus electrodes 11b and 12b that are used in the structure can be made of various materials such as a photosensitive material in addition to the above-described materials.

A black matrix BM 15, which performs a light blocking function of reducing reflection by absorbing external light that is generated from the outside of the upper substrate 10 and a function of improving purity and contrast of the upper substrate 10 is arranged between the transparent electrodes 11a and 12a and the bus electrodes 11b and 12b of the scan electrode 11 and the sustain electrode 12.

The black matrix 15 according to an embodiment of the present invention is formed in the upper substrate 10 and includes a first black matrix 15 that is formed in a position that is overlapped with a barrier rib 21 and second black matrixes 11c and 12c that are formed between the transparent electrodes 11a and 12a and the bus electrodes 11b and 12b. Here, the first black matrix and the second black matrixes 11c and 12c that are also referred to as a black layer or a black electrode layer may be physically connected to each other when they are formed at the same time in a forming process or may be not physically connected to each other when they are not formed at the same time.

Furthermore, when they are physically connected to each other, the first black matrix 15 and the second black matrixes 11c and 12c are made of the same material, but when they are physically separated from each other, they may be made of other materials.

An upper dielectric layer 13 and a protective film 14 are stacked in the upper substrate 10 in which the scan electrode 11 and the sustain electrode 12 are formed in parallel. Charged particles, which are generated by a discharge are accumulated in the upper dielectric layer 13 and perform a function of protecting the sustain electrode pair 11 and 12. The protective film 14 protects the upper dielectric layer 13 from sputtering of charged particles that are generated at a gas discharge and enhances emission efficiency of a secondary electron.

Furthermore, the address electrode 22 is formed in an intersecting direction of the scan electrode 11 and the sustain electrode 12. Furthermore, a lower dielectric layer 24 and a barrier rib 21 are formed on the lower substrate 20 in which the address electrode 22 is formed.

Furthermore, a phosphor layer 23 is formed on the surface of the lower dielectric layer 24 and the barrier rib 21. In the barrier rib 21, a vertical barrier rib 21a and a horizontal barrier rib 21b are formed in a closed manner and the barrier rib 21 physically divides a discharge cell and prevents ultraviolet rays and visible light that are generated by a discharge from leaking to adjacent discharge cells.

A filter 100 can be attached to an entire surface of the plasma display panel according to the present invention and the filter 100 can include an anti-reflection AR layer, a near infrared NIR blocking layer, an electromagnetic interference EMI blocking layer, or so on.

In an embodiment of the present invention, various shape of barrier rib structure as well as the barrier rib 21 structure shown in FIG. 1 can be used. For example, a differential barrier rib structure in which the vertical barrier rib 21a and the horizontal barrier rib 21b have different heights, a channel type barrier rib structure in which a channel, which can be used as an exhaust passage is formed in at least one of the vertical barrier rib 21a and the horizontal barrier rib 21b, and a hollow type barrier rib structure in which a hollow is formed in at least one of the vertical barrier rib 21a and the horizontal barrier rib 21b, can be used.

In the differential type barrier rib structure, it is more preferable that a height of the horizontal barrier rib 21b is higher than that of the vertical barrier rib 21a and in the channel type barrier rib structure or the hollow type barrier rib structure, it is preferable that a channel or a hollow is formed in the horizontal barrier rib 21b.

In an embodiment of the present invention, it is described as each of R, G, and B discharge cells is arranged on the same line, but they may be arranged in other shapes. For example, delta type of arrangement in which the R, G, and B discharge cells are arranged in a triangle shape may be also used. Furthermore, the discharge cell may have various polygonal shapes such as a quadrilateral shape, a pentagonal shape, and a hexagonal shape.

Furthermore, the phosphor layer 23 emits light by ultraviolet rays that are generated at a gas discharge and generates any one visible light among red color R, green color G, or blue color B light. Here, inert mixed gas such as He+Xe, Ne+Xe, and He+Ne+Xe for performing a discharge is injected into a discharge space that is provided between the upper and lower substrates 10 and 20 and the barrier rib 21.

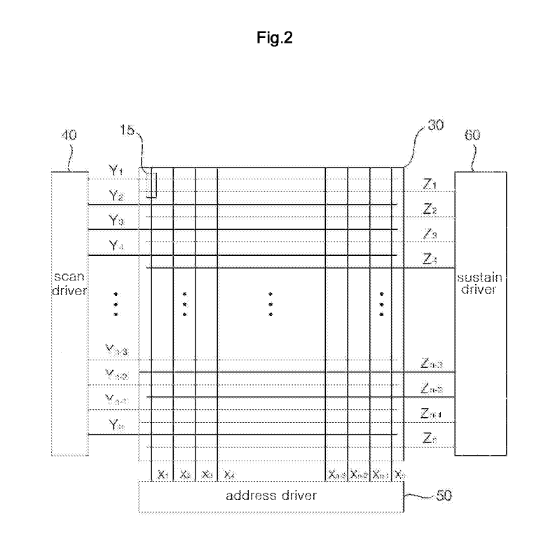

FIG. 2 is a diagram illustrating an embodiment of an electrode arrangement according to the plasma display panel.

It is preferable that a plurality of discharge cells constituting the plasma display panel is arranged in a matrix shape as shown in FIG. 2. Each of the plurality of discharge cells is disposed at intersections of scan electrode lines Y1 to Yn, sustain electrode lines Z1 to Zn, and address electrode lines X1 to Xn. The scan electrode lines Y1 to Yn may be sequentially or simultaneously driven and the sustain electrode lines Z1 to Zn may be simultaneously driven. The address electrode lines X1 to Xn may be driven by dividing into even-numbered lines and odd-numbered lines or may be sequentially driven. Because electrode arrangement shown in FIG. 2 is merely an embodiment of electrode arrangement of a plasma panel according to the present invention, the present invention is not limited to the electrode arrangement and the driving method of the plasma display panel shown in FIG. 2. For example, there may be used a dual scan mode in which two scan electrode lines among the scan electrode lines Y1 to Yn are scanned at the same time. Furthermore, the address electrode lines X1 to Xn may be driven by dividing into an upper and lower parts in a central part of the panel.

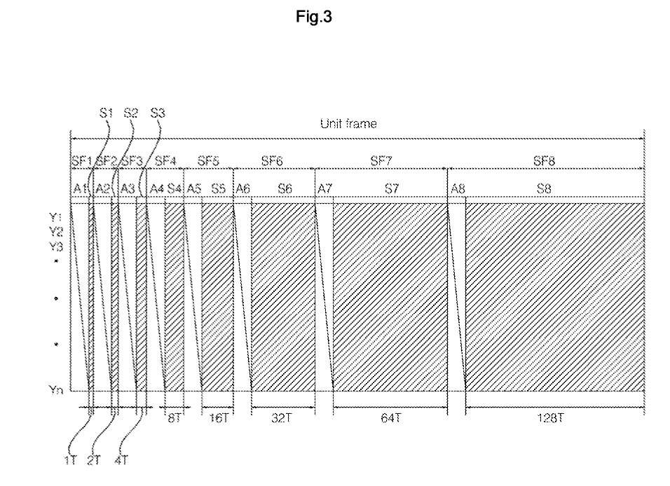

FIG. 3 is a timing chart illustrating an embodiment of a method of dividing one frame into a plurality of subfields and driving them in a time division manner. In order to realize time-divisional gray scale display, a unit frame may be divided into a predetermined number, for example, 8 subfields (SF1, . . . SF8). Furthermore, each subfield (SF1, . . . SF8) is divided into a reset period (not shown), an address period (A1, . . . A8), and a sustain period (S1, . . . S8).

According to one embodiment of the present invention, the reset period may be omitted in at least one of a plurality of subfields. For example, the reset period may exist in only a first subfield or in only the first subfield and middle level of subfields among entire subfields.

In each of address periods (A1, . . . A8), an address signal is applied to the address electrode X and a scan signal corresponding to each scan electrode Y is sequentially applied to each of scan electrode lines.

In each of the sustain periods (S1, . . . S8), a sustain signal is alternately applied to the scan electrode Y and the sustain electrode Z and in the address periods (A1, . . . A8), a sustain discharge is generated in discharge cells in which wall charges are formed.

Brightness of the plasma display panel is proportional to the number of sustain discharge pulses of a unit frame during the sustain discharge periods (S1, . . . S8). When one frame forming one image is expressed with 8 subfields and 256 gray scales, the number of different sustain signals may be allocated in order with a ratio of 1, 2, 4, 8, 16, 32, 64, and 128 in each subfield. For example, in order to obtain brightness of 133 gray scales, a sustain discharge is performed by addressing cells during a period of subfield 1, a period of subfield 3, and a period of subfield 8.

The sustain discharge number, which is allocated to each subfield may be variably determined by a weight of subfields depending on an automatic power control APC step. That is, FIG. 3 shows, as an example, a case of dividing one frame into 8 subfields, but the present invention is not limited thereto and the number of subfields forming one frame can be variously changed according to a design specification. For example, a plasma display panel can be driven by dividing one frame into 8 or more subfields such as 12 or 16 subfields.

Furthermore, the sustain discharge number, which is allocated to each subfield can be variously changed considering gamma characteristics or panel characteristics. For example, a degree of a gray scale that is allocated to subfield 4 can be lowered from 8 to 6 and that is allocated to subfield 6 can be raised from 32 to 34.

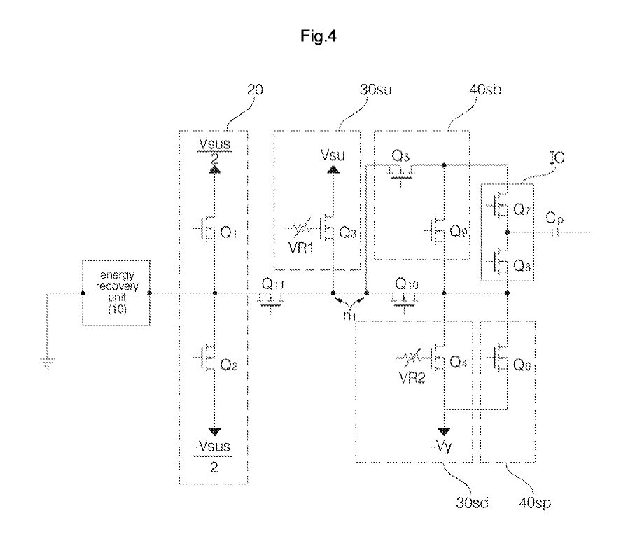

FIG. 4 is a circuit diagram illustrating a first embodiment of a driving circuit that is provided in a plasma display apparatus according to the present invention. The driving circuit shown in FIG. 4 includes an energy recovery unit 10, a sustain driver 20, a set-up signal applying unit 30su, a set-down signal applying unit 30sd, a scan bias signal applying unit 40sb, a scan pulse applying unit 40sp, and a scan IC (IC).

Referring to FIG. 4, the energy recovery unit 10 is connected to a sustain signal applying unit 20 so as to minimize loss due to reactive power generated by charging a panel capacitor Cp up to a sustain voltage and discharging again it during a sustain period.

The energy recovery unit 10 includes an inductor that forms an LC resonance current along with the panel capacitor Cp, a switch that is connected to the inductor, and a source capacitor that stores energy that is lost upon charging and discharging the panel. The resonance current is applied or recovered through a first node n1.

The panel capacitor Cp equivalently displays capacitance that is formed between the scan electrode Y and the sustain electrode Z.

As the first switch Q1, which is connected to a highest sustain voltage source Vsus/2 and the first node n1 therebetween is turned on by the control of a timing controller, the sustain driver 20 supplies a highest sustain voltage to the first node n1 on a path of a resonance current.

As the second switch Q2, which is connected to the first node n1 and a lowest sustain voltage source −Vsus/2 therebetween is turned on by the control of a timing controller, a sustain signal is generated by supplying the lowest sustain voltage to the first node n1.

A voltage value that is applied to each of elements that are included in a driving circuit varies depending on a voltage value that is applied to the first node n1. Accordingly, in the present embodiment, for example, by setting a voltage value of the first node n1 to a ground level, a highest sustain voltage to Vsus/2, and the lowest sustain voltage to −Vsus/2, an operation of a driving circuit according to the present invention will be described.

A reset signal applying unit includes a set-up signal applying unit 30su for applying a set-up signal and a set-down signal applying unit 30sd for applying a set-down signal during a reset period.

As a set-up switch Q3 that is connected to a set-up voltage source Vsu and the first node n1 therebetween is turned on by the control of a timing controller, the set-up signal applying unit 30su supplies a ramp form of set-up signal that rises up to a set-up voltage to the first node n1. A variable resistance VR1 for adjusting an inclination of the ramp waveform is connected to a control terminal of the set-up switch Q3.

As a set-down switch Q4 that is connected to the first node n1 and the scan voltage source −Vy therebetween is turned on by the control of a timing controller, the set-down signal applying unit 30sd supplies a ramp form of set-down signal falling up to a set-down voltage to the first node n1. A variable resistance VR2 for adjusting an inclination of the ramp waveform is connected to a control terminal of the set-down switch Q4.

A scan signal applying unit includes a scan bias signal applying unit 40sb for applying a scan bias voltage and a scan pulse applying unit 40sp for applying a scan pulse during an address period.

A scan bios signal applying unit 40sb includes a scan switch Q5 for applying a scan bias signal to a panel capacitor Cp during an address period and the scan switch Q5 and the set-up switch Q3 are connected to the first node n1.

As shown in FIG. 4, a lowest sustain voltage source −Vsus/2 of the sustain driver 20 may be used as a scan bias voltage source, which is a voltage source for supplying the scan bias voltage to the panel capacitor Cp. If an address period is started as the scan switch Q5 is turned on, a scan bias voltage is generated as a waveform that is fallen up to the scan voltage source −Vy rises up to the lowest sustain voltage source −Vsus/2.

The scan pulse applying unit 40sp includes a scan pulse switch Q6 that is connected to the scan voltage source −Vy. As the scan pulse switch is turned on, a scan signal falling from the scan bias voltage −Vsus/2 to the scan voltage source −Vy is applied to generate an address discharge.

The scan IC (IC) includes a scan-up switch Q7 and a scan-down switch Q8. A voltage of the first node n1 is applied to the panel capacitor Cp or a voltage that is charged to the panel capacitor Cp is discharged depending on turning-on of switches Q7 and Q8 constituting the scan IC (IC).

As shown in FIG. 4, as the scan switch Q5 is connected to the first node n1, a voltage of Vsus/2 is applied to the first node n1 and the panel capacitor Cp at a time point when a sustain period is ended.

As a voltage of the first node n1 and that of the panel capacitor Cp are the same, a voltage that is applied to both ends Cp of the set-up switch Q3 becomes 0V even if a set-up signal is applied to the panel capacitor depending on turning-on of the scan switch Q5. Therefore, during a set-up period, a withstanding voltage of the scan switch Q5 can be prevented from exceeding.

Furthermore, during a reset period, the first path-blocking element Q11 can be connected to the sustain driver 20 and the first node n1 therebetween so that a set-up signal is applied to the panel capacitor Cp through the first node n1. The first path-blocking element Q11 element may be a FET switch, a diode element, or so on.

As shown in FIG. 4, the second path-blocking element Q10 can be connected to the first node n1 and the scan IC (IC) therebetween so that a scan bias signal is applied to the panel capacitor Cp through the first node n1 and the scan switch Q5 during an address period. The first path-blocking element Q11 may be an element such as a FET switch or a diode.

While a set-down signal falling to the scan voltage source −Vy is applied to the panel capacitor Cp during a set-down period, the second path-blocking element Q10 is turned off to block a current pass from the first node n1.

While a scan signal falling from the scan bias voltage to the scan voltage −Vy is applied to the panel capacitor Cp during an address period, the second path-blocking element Q10 is turned off to block a current pass from the first node n1.

As shown in FIG. 4, it is preferable that a set-down switch Q6 for applying a set-down signal to the panel capacitor Cp is connected to the second path-blocking element Q10 and the scan IC (IC) therebetween and the set-down voltage source uses the same source −Vy as the scan voltage source.

The complementary scan switch Q9, which complementarily operates with the scan switch Q5, that is, which is turned off when the scan switch Q5 is turned on and which is turned on when the scan switch Q5 is turned off, can be connected in parallel to the scan IC (IC). The complementary scan switch Q9 is turned on to form a current pass in which a voltage that is applied to the panel capacitor Cp falls up to the lowest sustain voltage source −Vsus/2 during a sustain period.

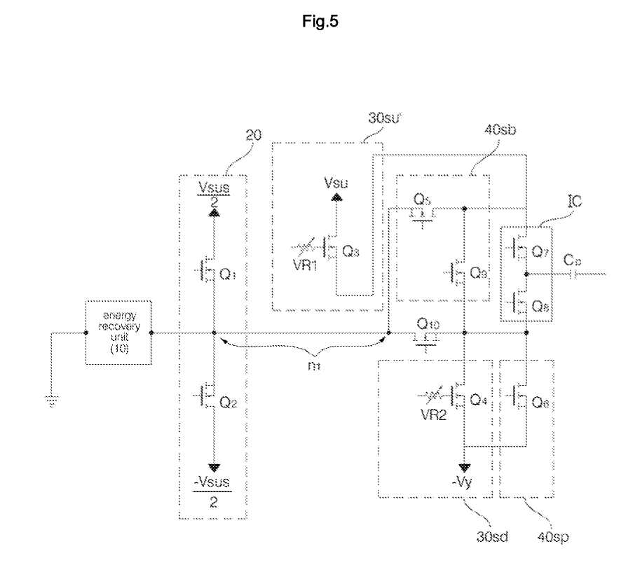

FIG. 5 is a circuit diagram illustrating a second embodiment of a driving circuit that is provided in the plasma display apparatus according to the present invention. The driving circuit shown in FIG. 5 includes an energy recovery unit 10, a sustain driver 20, a set-up signal applying unit 30su′, a set-down signal applying unit 30sd, a scan bias signal applying unit 40sb, a scan pulse applying unit 40sp, and a scan IC (IC).

Description of the same element as a driving circuit shown in FIG. 4 among elements of the driving circuit shown in FIG. 5 is omitted.

Referring to FIG. 5, the set-up switch Q3, which is included in the set-up signal applying unit 30su′ can be directly connected to the scan IC (IC) so that the set-up signal is directly applied to the panel capacitor Cp without passing through the first node n1 during a reset period.

That is, in the first embodiment of a driving circuit shown in FIG. 4, the set-up signal is applied to the panel capacitor Cp through a current pass that is connected to the set-up voltage source Vsu, the set-up switch Q3, the first node n1, the second path-blocking switch Q10, and scan IC (IC), but in the second embodiment shown in FIG. 5, the set-up signal is applied to the panel capacitor Cp through a current pass that is connected to the set-up voltage source Vsu, the set-up switch Q3, and the scan IC (IC).

In the second embodiment shown in FIG. 5, a voltage of Vsus/2 is applied to the first node n1 at a time point when a sustain period is ended and there is no change in a voltage that is applied to the first node n1 even at a time point when a set-up period is started. Accordingly, a voltage that is applied to the panel capacitor Cp by the set-up signal applying unit 30su′ rises.

As shown in FIG. 5, because the set-up signal applying unit 30su′ is directly connected to the scan IC (IC), there may be omitted the first path-blocking element Q11 of FIG. 4 for blocking a set-up signal from being applied to the sustain driver 20 side. Accordingly, the first node n1 is directly connected to the sustain driver 20.

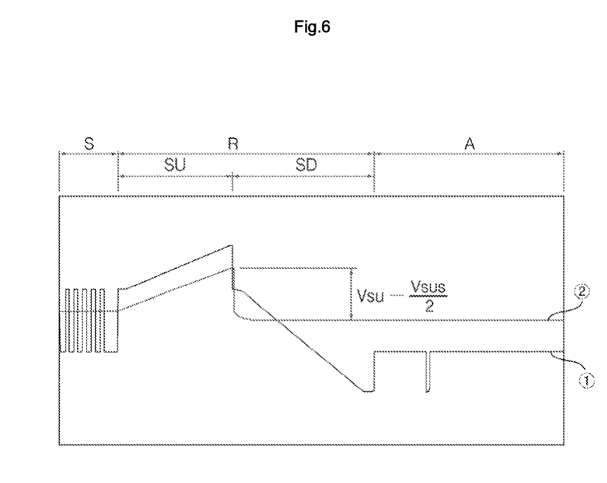

FIG. 6 is a timing chart illustrating a first embodiment of a driving signal waveform according to the plasma display panel.

As shown in FIG. 6, during a set-up period, one end of the scan switch Q5 is connected to the first node n1 that maintains \textcircled{2} a voltage of Vsus/2 and the other end of the scan switch Q5 is connected to the panel capacitor Cp that rises \textcircled{1} up to the set-up voltage source Vsu such that a highest voltage that is applied to both ends of the scan switch Q5 becomes Vsu-Vsus/2. Therefore, during a set-up period, a voltage, which is applied to both ends of the scan switch Q5 decreases, compared to a conventional driving circuit.

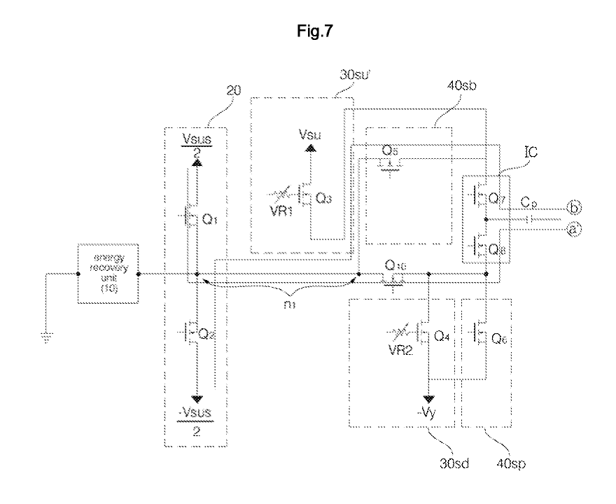

FIG. 7 is a circuit diagram illustrating a third embodiment of a driving circuit that is provided in a plasma display apparatus according to the present invention. The driving circuit shown in FIG. 7 includes the energy recovery unit 10, the sustain driver 20, the set-up signal applying unit 30su′, the set-down signal applying unit 30sd, the scan bias signal applying unit 40sb, the scan pulse applying unit 40sp, and the scan IC (IC).

Description of the same element as a driving circuit shown in FIG. 4 among elements of the driving circuit shown in FIG. 7 is omitted.

In the set-up signal applying unit 30su′, the set-up switch Q3, which is connected to the set-up voltage source Vsu and the scan IC (IC) therebetween is turned on to directly apply a ramp form of set-up signal that rises up to a set-up voltage to the panel capacitor Cp. A variable resistance VR1 for adjusting an inclination of the ramp waveform is connected to a control terminal of the set-up switch Q3.

As shown in FIG. 7, since the set-up signal is directly applied to the panel capacitor Cp without passing through the first node n1, a path-blocking switch Q11 as shown in FIG. 4 for blocking a current pass of the first node n1 may be omitted.

Since the set-down switch Q4, which is connected to the scan IC (IC) and the scan voltage source −Vy therebetween is turned on, the set-down signal applying unit 30sd applies a ramp form of set-down signal that falls up to the scan voltage −Vy to the panel capacitor Cp. A variable resistance VR2 for adjusting an inclination of the ramp waveform is connected to a control terminal of the set-down switch Q4.

The scan bios signal applying unit 40sb includes a scan switch Q5 for applying a scan bias voltage to the panel capacitor Cp and the scan switch Q5 is connected to a lowest sustain voltage source −Vsus/2 that is used as a scan bias voltage source through the first node n1.

The scan pulse applying unit 40sp includes a scan pulse switch Q6 that is connected to the scan IC (IC) and the scan voltage source −Vy therebetween. As the scan pulse switch Q6 is turned on, a scan pulse that falls from the scan bias voltage −Vsus/2 to the scan voltage source −Vy is applied to the panel capacitor Cp.

As shown in FIG. 7, during a sustain period, the lowest sustain voltage −Vsus/2 is applied \textcircled{b}′ to the panel capacitor Cp through the first switch Q1, the first node n1, the scan switch Q5, and the scan-up switch Q7 and the highest sustain voltage Vsus/2 is applied \textcircled{a}′ to the panel capacitor Cp through the second switch Q2, the first node n1, the second path-blocking switch Q10, and the scan-down switch Q8.

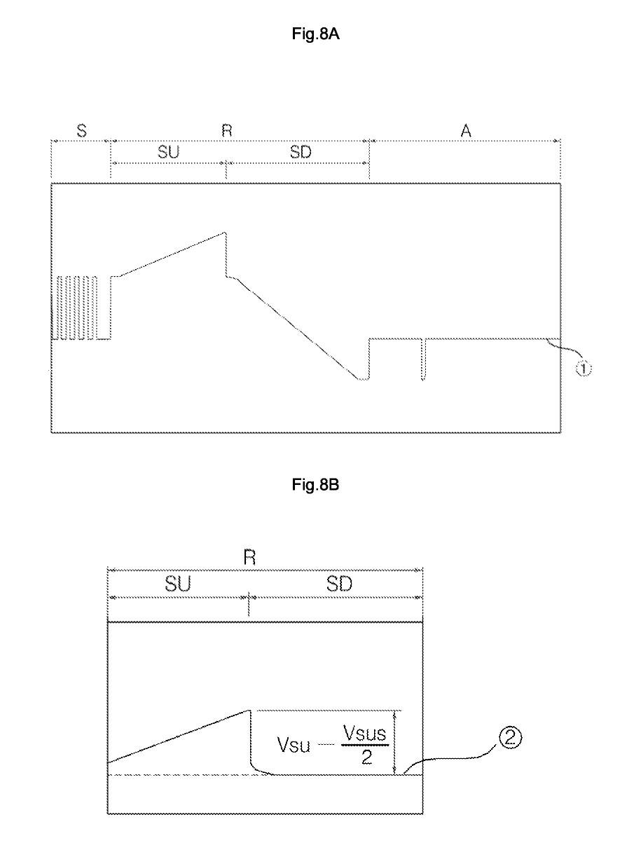

FIGS. 8A, 8B, and 8C are timing charts illustrating the second to fourth embodiments of a driving signal waveform of the plasma display panel.

Referring to FIG. 8A, the reset period R is a period of erasing wall charges that are formed by a previous sustain discharge and initializing a state of each cell and is divided into a set-up period SU of supplying a rising set-up signal and a set-down period SD of supplying a falling set-down signal.

The set-up signal is supplied through the set-up switch Q3 and the scan-up switch Q7 from the set-up voltage source Vsu and the set-down signal is supplied through the set-down switch Q4 and the scan-down switch Q8 from the scan voltage source −Vy.

In the address period A as a period of selecting a cell to discharge, the scan bias voltage is applied to the panel capacitor Cp through the second switch Q2, the first node n1, the scan switch Q5, and the scan-up switch Q7 from the scan bias voltage source −Vsus/2 and an address discharge is generated as the scan bios voltage is applied to the panel capacitor Cp through the scan pulse switch Q6 and the scan-down switch Q8 from the scan voltage source −Vy at a moment when it is synchronized with a data pulse.

In the sustain period S as a period of alternately applying a sustain signal to the scan electrode and the sustain electrode, a highest sustain voltage is applied to the panel capacitor Cp through the first switch Q1, the first node n1, the second path-blocking element Q1, and the scan-down switch Q8 from the highest sustain voltage source Vsus/2 and a lowest sustain voltage is applied to the panel capacitor Cp through the second switch Q2, the first node n1, the scan switch Q5, and the scan-up switch Q7 from the lowest sustain voltage source −Vsus/2, so that a sustain discharge is generated.

FIGS. 5 and 6 show a voltage that is applied to both ends of the scan switch Q5 and the second path-blocking element Q10, where a voltage of both ends decreases, compared to a conventional driving circuit.

As shown in FIG. 5, a set-up signal is directly applied to the panel capacitor Cp through the set-up voltage source Vsu, the set-up switch Q3, and the scan IC (IC) during a set-up period SU in which a withstanding voltage of the scan switch Q5 rose and a voltage of the first node n1 is maintained during the set-up period, so that a highest voltage, which is applied to both ends of the scan switch Q5 becomes Vsu-Vsus/2.

Furthermore, in a sustain period where a withstanding voltage of the first path-blocking element Q10 rose, as an applying path of a lowest sustain voltage is formed through the first node n1 and the scan switch Q5, a resonance current and a discharge current flowing to the first path-blocking element Q10 are reduced to a half, so that a highest voltage, which is applied to both ends of the first path-blocking element Q10 become Vsus/2.

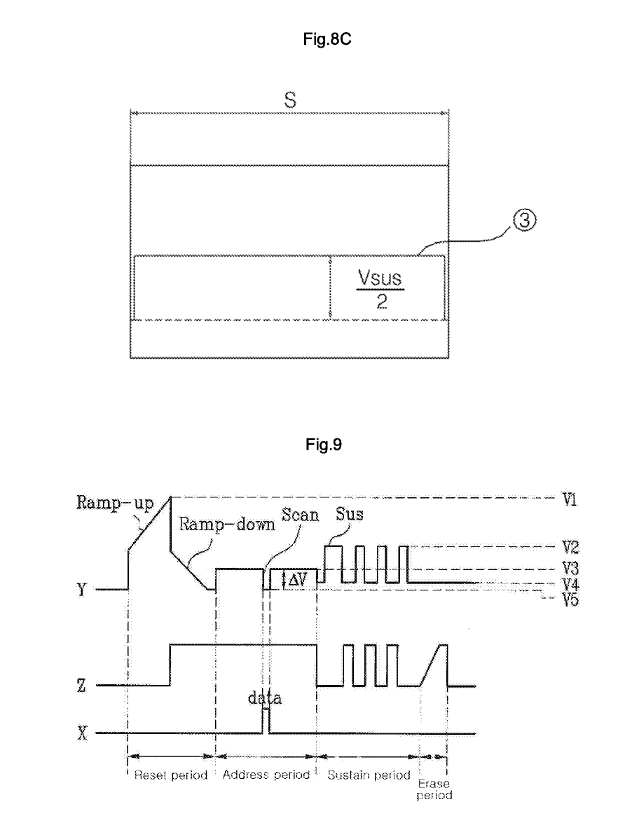

FIG. 9 is a timing chart illustrating a fifth embodiment of a driving signal waveform according to the plasma display panel.

In order to generate driving signals as shown in FIG. 9, a DC/DC converter is required to generate a potential corresponding to a driving signal Y, Z, or X in each period. For example, in case of the signal Y, the DC/DC converter is required to generate a ramp-up pulse voltage V1 that is used during a reset period and to generate a scan bias voltage V3 and a negative scan voltage (or a ramp-down pulse voltage) V5 that is used during an address period. Furthermore, the DC/DC converter is required to generate a highest sustain voltage V2 and a lowest sustain voltage V4 that is used during a sustain period. In general, the highest sustain voltage V2 may correspond to a sustain voltage Vsus and the lowest sustain voltage V4 may be a reference potential Vref. Alternatively, a plasma display apparatus according to an embodiment of the present invention can be driven in a half sustain mode and at this case, a highest sustain voltage V2 may be Vsus/2 and a lowest sustain voltage V4 may be −Vsus/2.

Because potentials requiring in each period are different from each other, a DC/DC converter is required to convert from a DC voltage having a predetermined level to another DC voltage having a corresponding level.

Furthermore, a fixed voltage difference AV is required between a negative scan voltage V5 and a scan bias voltage V3. However, as the negative scan voltage V5 changes, it is required to change a level of the scan bias voltage V3.

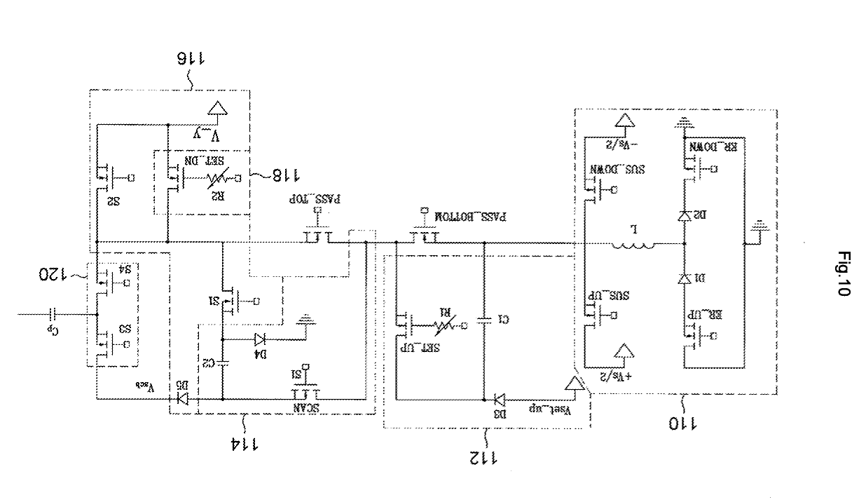

FIG. 10 is a circuit diagram illustrating a fourth embodiment of a driving circuit that is provided in a plasma display apparatus according to the present invention. A driving circuit shown in FIG. 10 includes a sustain signal applying unit 110, a set-up signal applying unit 112, a charging unit 114, a scan bios signal applying unit 116, a set-down signal applying unit 118, a scan IC 120, and path-blocking switches PASS_BOTTOM and PASS_TOP. Description of the same element as the driving circuit shown in FIG. 4 among elements of the driving circuit shown in FIG. 10 is omitted.

Referring to FIG. 10, the sustain signal applying unit 110 includes an energy recovery unit and a sustain driver. The charging unit 114 includes a scan switch SCAN, a capacitor C2, and a diode D4. The diode D4 has a positive electrode and a negative electrode that are provided between the capacitor C2 and a reference potential.

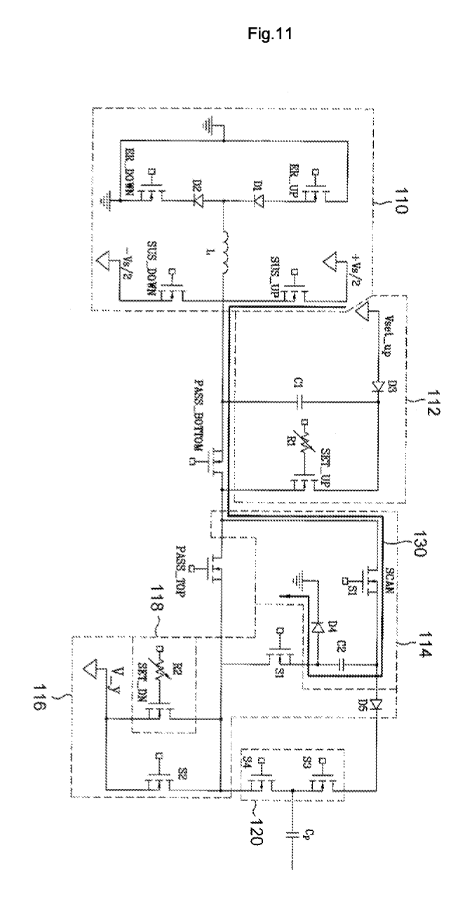

FIG. 11 shows a current pass of the driving circuit shown in FIG. 10 in a sustain period. The charging unit 114 charges a highest sustain voltage +Vsus/2 that is applied to the panel capacitor Cp in a sustain period.

That is, in a sustain period, a sus-up switch SUS_UP, a first path-blocking switch PASS_BOTTOM, and a scan switch SCAN are turned on and a sus-down switch SUS_DOWN and a second path-blocking switch PASS_TOP are turned off. Accordingly, because a current path, which is connected to a reference potential via the switches SUS_UP, PASS_BOTTOM, and SCAN and then the capacitor C2 and the diode D4, is formed in an arrow direction 130, a sustain-up voltage +Vsus/2 can be charged to the capacitor C2.

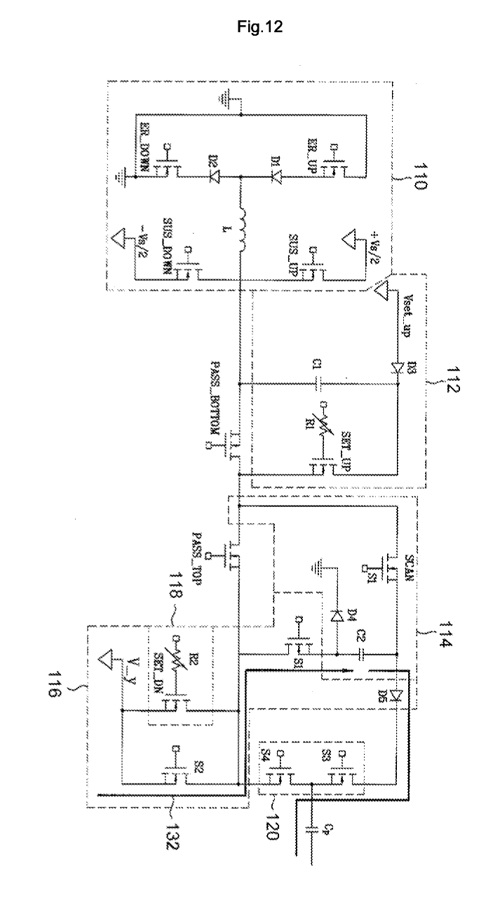

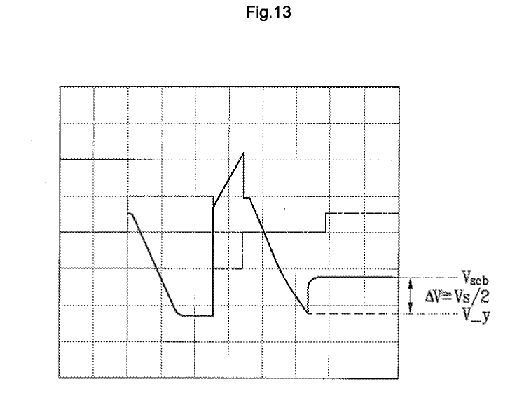

FIG. 12 shows a current pass of the driving circuit shown in FIG. 10 in a sustain period. FIG. 13 is a timing chart illustrating a sixth embodiment of a driving signal waveform according to the plasma display panel.

Referring to FIGS. 12 and 13, the scan bias signal applying unit 116 applies a voltage having a level higher by a level of a sustain-up voltage +Vs/2 than a set-down voltage V_y as a scan bias voltage Vscb to the panel capacitor Cp in an address period.

The scan bios signal applying unit 116 includes the first and second switches S1 and S2 and a diode D5. The first and second switches S1 and S2 are connected to the set-down voltage source V_y and the charging unit 114 therebetween and turned on in an address period. The diode D5 has a positive electrode and a negative electrode that are connected to each of a contact point of the capacitor C2 and the scan switch SCAN and the scan-up switch S3 of the scan IC 120.

In an address period, the first and second switches S1 and S2 and the scan-up switch S3 are turned on and the set-down switch SET_DN, the second path-blocking switch PASS_TOP, and the scan-down switch S4 are turned off. Accordingly, a current pass 130, which is connected to the panel capacitor Cp via the first and second switches S1 and S2, the capacitor C2, the diode D5, and the scan-up switch S3, is formed.

As the first switch S1 is turned on, a voltage +Vsus/2 that is charged to the capacitor C2 starts a discharge and as shown in FIG. 12, a scan bias voltage is floated as a voltage higher than a set-down voltage V_y. Referring to FIG. 12, the scan bias voltage Vscb and the set-down voltage V_y maintain a voltage difference ΔV.

As shown in FIG. 10, a driving circuit of the plasma display apparatus according to the present invention does not have a separate scan voltage source Vsc, connects the scan switch SCAN to the first path-blocking switch PASS_BOTTOM, and has the charging unit 114, thereby generating a scan bias voltage Vscb without a separate DC/DC converter.

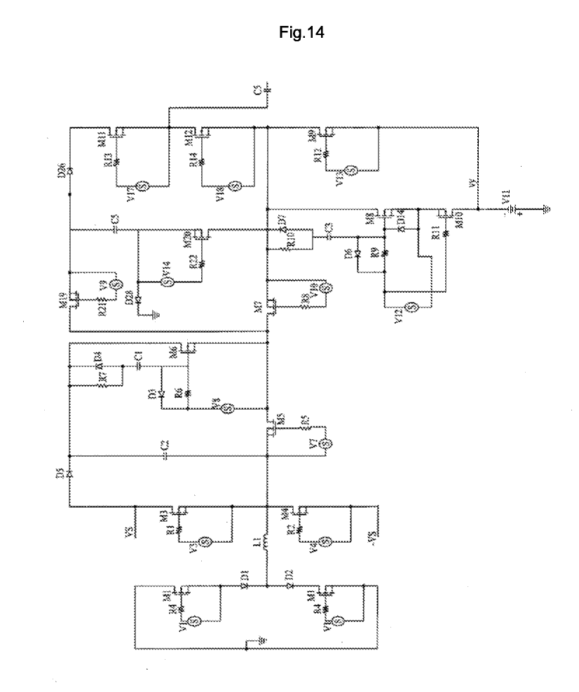

FIG. 14 is a circuit diagram illustrating a fifth embodiment of a driving circuit that is provided in a plasma display apparatus according to the present invention, where a sustain voltage Vsus is assumed to 100V.

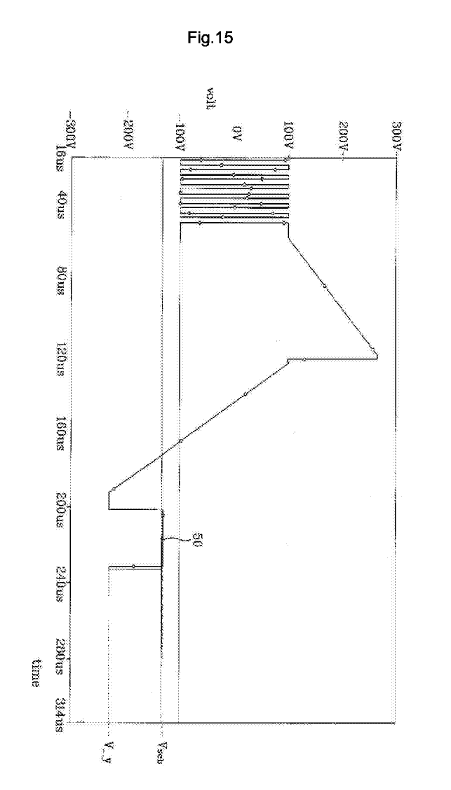

FIG. 15 is a timing chart illustrating a seventh embodiment of a driving signal waveform according to the plasma display panel, where a waveform of a driving signal, which is applied to the panel capacitor Cp by the circuit diagram shown in FIG. 14 is shown. Referring to FIG. 14, it can be seen that a scan bias voltage Vscb 50 is floated by ΔV, compared to the set-down voltage V_y.

A plasma display apparatus of the present invention having the above-described construction reduces a voltage that is applied to both ends of a scan switch during a set-up period by converting circuit connection of a scan switch of applying a scan bias signal and circuit connection of a set-up switch of applying a set-up signal to each other, so that the durability of a switch element is improved and a manufacture cost can be reduced by selecting a switch element having a low withstanding voltage.

Furthermore, a circuit cost can be reduced by removing a DC power source Vsc required for generating a scan bias voltage Vscb in an address period. Unlike a conventional PDP driving apparatus in which a scan bias voltage is held to only a specific potential −Vsus/2 or GND, a scan bias voltage Vscb can be held with a specific voltage ΔV against a set-down voltage V_y, whereby the degree of freedom in a waveform is high, so that the degree of freedom of a waveform depending on an actual driving condition can be improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a scan-up switch and a scan-down switch whose one ends are connected to the panel so as to apply a scan signal to a panel; and
a scan switch that is connected to a node that is positioned on a path of a resonance current flowing to the panel and the scan-up switch therebetween.

2. The plasma display apparatus of claim 1, further comprising a set-up switch that is connected to the node to be turned on so as to apply a set-up signal to the panel.

3. The plasma display apparatus of claim 1, further comprising:
a sustain driver that applies a sustain signal to the panel; and
a first path-blocking element that is connected to the sustain driver and the node therebetween.

4. The plasma display apparatus of claim 1, wherein a second path-blocking element that is connected to the node and the other end of the scan-down switch therebetween.

5. The plasma display apparatus of claim 1, further comprising a complementary scan switch that complementarily operates with the scan switch so as to apply a lowest sustain voltage to the panel.

6. The plasma display apparatus of claim 5, wherein one end of the complementary scan switch is connected to the scan switch and the scan-up switch and the other end thereof is connected to the scan-down switch.

7. The plasma display apparatus of claim 1, further comprising a set-up switch whose one end is connected to the scan switch and the scan-up switch to be turned on so as to apply a set-up signal to the panel.

8. The plasma display apparatus of claim 1, further comprising a scan pulse switch that is connected to the scan-down switch and a scan voltage source therebetween to be turned on so as to apply a scan bias voltage to the panel.

9. The plasma display apparatus of claim 1, further comprising a sustain driver that applies a sustain signal to the panel,
wherein a lowest sustain voltage source of the sustain driver is used as a scan bias voltage source.

10. A plasma display apparatus comprising:
a scan-up switch and a scan-down switch whose one ends are connected to the panel so as to apply a scan signal to a panel;
a scan switch that is connected to a node that is positioned on a path of a resonance current flowing to the panel and the scan-up switch therebetween; and
a set-up switch whose one end is connected to the node and whose the other end is connected to the other end of the scan-up switch to be turned on so as to apply a set-up signal to the panel.

11. The plasma display apparatus of claim 10, further comprising a path-blocking switch that is connected to the node and the scan-down switch therebetween.

12. The plasma display apparatus of claim 11, further comprising a sustain driver that applies a sustain signal to the panel,
wherein the path-blocking switch is turned on to apply a highest sustain voltage that is output from the sustain driver to the panel.

13. The plasma display apparatus of claim 10, further comprising a sustain driver that applies a sustain signal to the panel,
wherein the scan switch is turned on to apply a lowest sustain voltage that is output from the sustain driver to the panel.

14. A plasma display apparatus comprising:
a charging unit that charges a sustain voltage that is applied to a panel during a sustain period; and
a scan signal applying unit that applies a scan bias voltage higher than a set-down voltage, which is a lowest voltage of a set-down signal to the panel using a voltage that is charged in the charging unit.

15. The plasma display apparatus of claim 14, wherein the scan bias voltage is substantially equal to the sum of the set-down voltage and a voltage that is charged in the charging unit.

16. The plasma display apparatus of claim 14, further comprising a sustain driver that outputs a sustain voltage that is applied to the panel, and the charging unit comprises
a capacitor; and
a scan switch that is connected to the capacitor and the sustain driver therebetween to be turned on so that a sustain voltage, which is output from the sustain driver is charged to the capacitor.

17. The plasma display apparatus of claim 16, further comprising a diode whose a positive electrode is connected to one end of the capacitor and whose a negative electrode is connected to a reference voltage source.

18. The plasma display apparatus of claim 14, wherein the scan signal applying unit comprises
a scan pulse switch that is turned on so as to supply the set-down voltage to the panel; and
a first switch that is connected to the charging unit and the scan pulse switch therebetween to be turned on so that a scan bias voltage higher than the set-down voltage is applied to the panel.

19. The plasma display apparatus of claim 18, further comprising:
a scan-up switch and a scan-down switch whose one ends are connected to the panel so as to apply a scan signal to the panel; and
a diode whose a positive electrode is connected to the charging unit and whose a negative electrode is connected to the other end of the scan-up switch.

20. The plasma display apparatus of claim 14, wherein it operates in a half sustain mode.
